(19) United States
(12) Patent Application Publication
(10) Pub. No.: US 2008/0126632 A1
(43) Pub. Date: May 29, 2008

(54) STIMULATING AND RECEIVING TEST/DEBUG DATA FROM A SYSTEM UNDER TEST VIA A DRONE CARD PCI BUS

(76) Inventors: Heinz Baier, Singelfingen (DE); Robert W. Berry, Round Rock, TX (US); Nicole Criscolo, Cedar Park, TX (US); Brian Flachs, Georgetown, TX (US); Steven J. Smolski, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/470,507

(22) Filed: Sep. 6, 2006

(51) Int. Cl. G06F 13/00

(52) U.S. Cl. 710/100

(57) ABSTRACT

A computer-implementable method, system and computer-usable medium for aiding in debugging operations of a System Under Test (SUT) through the use of an external DRONE card is presented. System test software that is running on the SUT “sets aside” debug/status information in a reserved/dedicated Peripheral Component Interface (PCI) section of system memory in the SUT. This information is communicated between the SUT and a DRONE card via a PCI bus. Debug/status information is thus accessed and manipulated by the DRONE card without disturbing (interrupting) normal operations of the SUT.

### CROSS REFERENCE TO RELATED APPLICATIONS

The present application is related to the following U.S. patent applications filed concurrently herewith: U.S. patent application Ser. No. ______ (Docket No. AUS920060406US1); U.S. patent application Ser. No. ______ (Docket No. AUS920060407US1); and U.S. patent application Ser. No. ______ (Docket No. AUS920060409US1). The above-mentioned patent applications are assigned to the assignee of the present invention and are incorporated herein by reference in their entirety.

### BACKGROUND OF THE INVENTION

The present invention relates in general to the field of computers and other data processing systems, including hardware, software and processes. More particularly, the present invention pertains to controlling debugging operations of a System Under Test (SUT) through the use of an external DRONE card that has an ability to assist in the debugging of the SUT.

Most software debuggers for microprocessors communicate with a user via a simple serial interface or Ethernet. For example, as shown in FIG. 1, a System Under Test (SUT) 102 sends and receives debug information to and from a user 104 via a serial interface 106. The user 104 utilizes a debug program (not shown) to debug hardware and software that is running on the SUT 102. Using this methodology, software being tested in the SUT 102 “pushes” debug information out of the SUT 102 by first interrupting the normal operation of the software being tested, and then transferring data to the user 104. This is disruptive to the real-time state of both the software being tested, as well as underlying hardware in the SUT 102.

### SUMMARY OF THE INVENTION

The present invention recognizes the need for a system to aid in debugging software that does not unduly interfere with normal operations of the software that is being debugged. Thus, presented herein are an improved computer-implementable method, system and computer-usable medium for aiding in debugging operations of a System Under Test (SUT) through the use of an external DRONE card. System test software that is running on the SUT “sets aside” debug/status information in a reserved/dedicated Peripheral Component Interface (PCI) section of system memory in the SUT. This information is communicated between the SUT and a DRONE card via a PCI bus. Debug/status information is thus accessed and manipulated by the DRONE card without disturbing (interrupting) normal operations of the SUT.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts a prior art debugging system in which debug data is transmitted to a user via a serial interface;

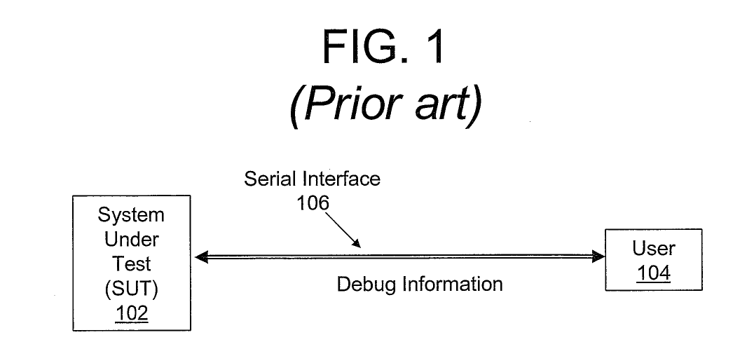

FIG. 2 illustrates an inventive DRONE card utilized by the present invention to optimize debugging operations of a System Under Test (SUT);

FIG. 3 depicts additional detail of the SUT and DRONE card; and

FIG. 4 is a flow-chart of exemplary steps taken by the present invention to aid in debugging operations of the SUT.

### DETAILED DESCRIPTION OF THE PREFERRED EMBODIMENT

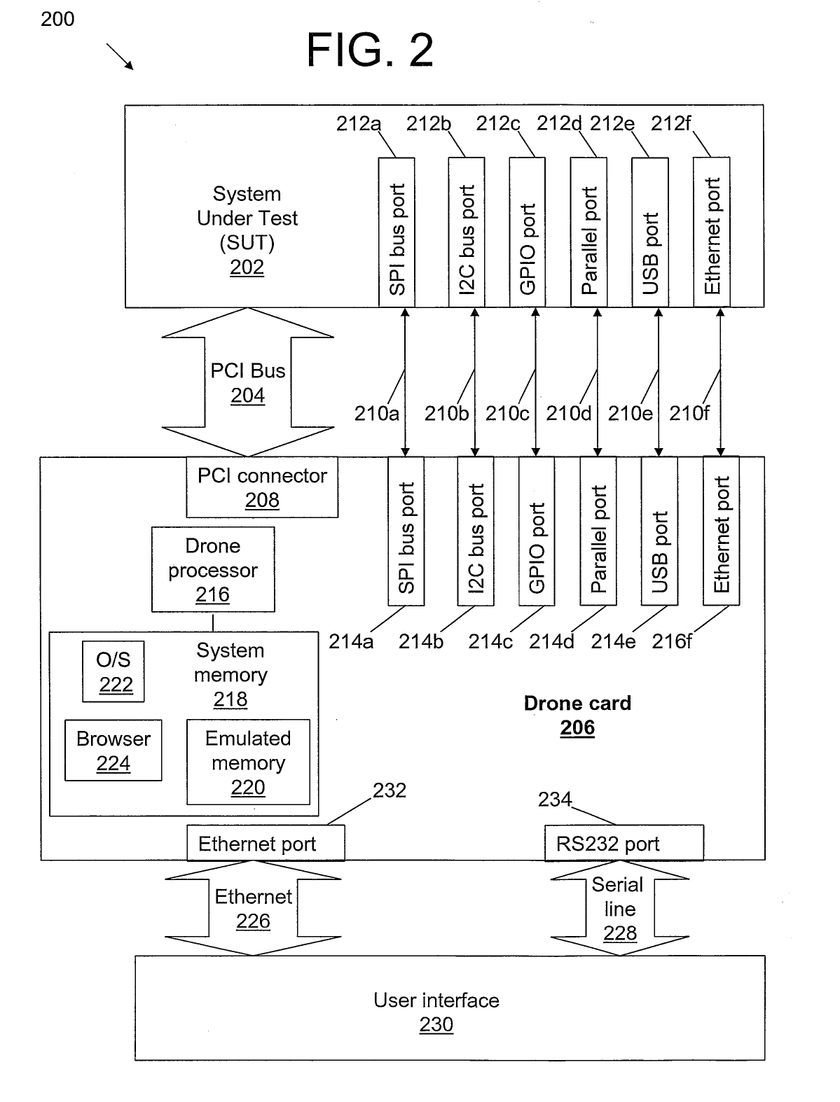

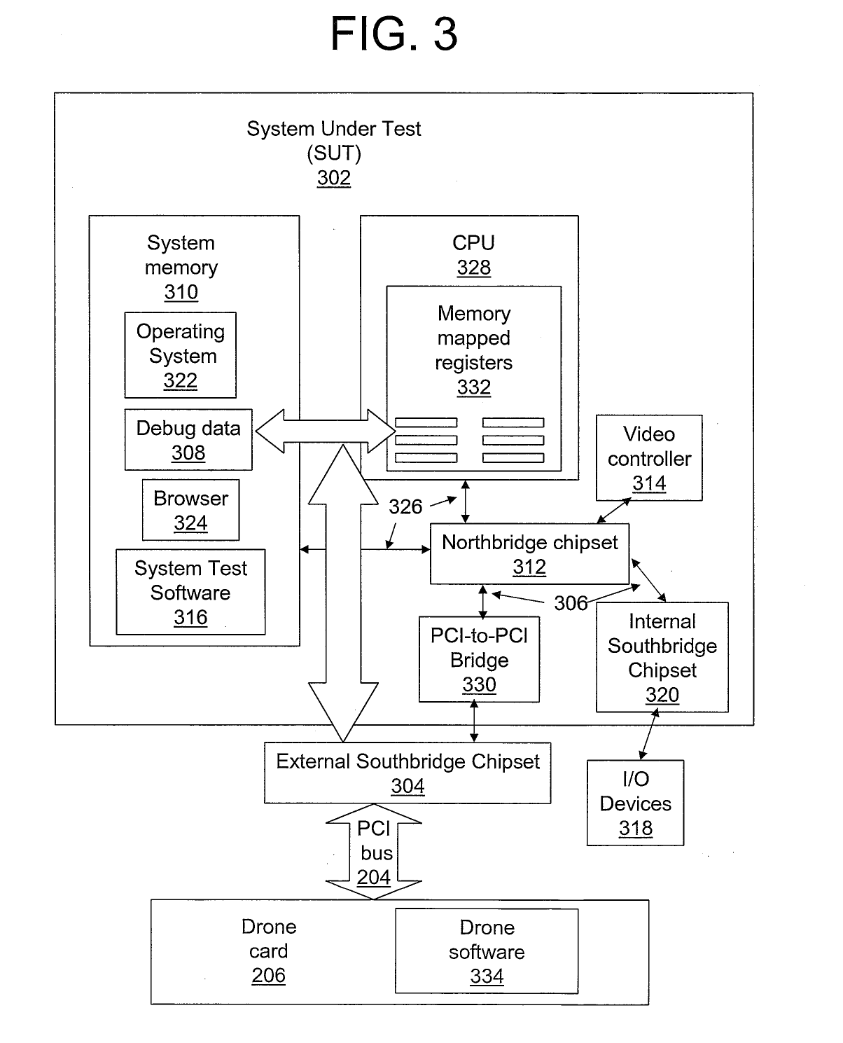

With reference now to FIG. 2, a hardware setup 200 is presented in accordance with the present invention. A System Under Test (SUT) 202, which has one or more software and/or hardware components to be debugged, interfaces with a Peripheral Component Interface (PCI) bus 204 to couple to a DRONE card 206. As shown in FIG. 3, an exemplary PCI interface is afforded by an external Southbridge chipset 304, which uses a PCI-to-PCI bridge 330 to couple external Southbridge chipset 304 to in internal PCI bus 306 in SU 302. Alternatively, an internal PCI bus (e.g., PCI bus 306 shown in FIG. 3) is directly coupled to DRONE card 206. In either configuration (with or without the external Southbridge chipset 304), DRONE card 206 effectively plugs directly into PCI bus 204 via a PCI connector 208.

If a particular test/debugging session requires further Input/Output (I/O) stimulus/communication (described in further detail below), appropriate cabling can be directly attached between SUT 202 and DRONE card 206. For example, a cable 210a connects Serial Peripheral Interface (SPI) bus port 212a in SUT 202 with SPI bus port 214a in DRONE card 206, thus permitting DRONE card 206 to directly communicate with the SPI bus (not shown) in SUT 202. Similarly, cable 210b couples Inter-Integrated Circuit (I2C) bus port 212b with I2C bus port 214b; cable 210c couples General Purpose Input/Output (GPIO) port 212c with GPIO 214c; cable 210d couples parallel port 212d with parallel port 214d; cable 210e couples Universal Serial Bus (USB) port 212e with USB port 214e; and cable 210f couples Ethernet port 212f with Ethernet port 216f. Through the use of such cabling and ports, allowing DRONE card 206 to have direct access to various busses in SUT 202, DRONE card 206 is able to directly control various debugging operations. For example, hardware in SUT 202 can be configured by DRONE card directly accessing the I2C bus (or, alternatively, the SPI bus) in SUT 202. Similarly, timing synchronization for injecting or retrieving data into SUT 202 (e.g., into the PCI data portion of the system memory in SUT 302 and/or the memory mapped registers in the Central Processing Unit (CPU) in SUT 302) can be directly controlled via any bus that supports the GPIO's in the SUT 302. Such GPIO's can also be used to power-up and/or reset SUT 302.

Note that DRONE card 206 includes a DRONE processor 216. Coupled to DRONE processor 216 is a system memory 218, which in one embodiment is made up of Dynamic Random Access Memory (DRAM). The system memory 218 includes an emulated memory 220, which contains a copy of debug data 308 found in the SUT's system memory 310 (shown in FIG. 3).

Drone card 206 is also capable of stimulating specific subsystems in SUT 302 for software debug and data gathering. That is, by accessing PCI bus 204 or one of the ports 212a-f in SUT 302, DRONE card 206 can cause a signal or data to be passed to SUT 302, which results in activity in software or hardware in SUT 302. For example, a signal can be sent from DRONE card 206, via a Northbridge chipset 312 to a video controller 314, which results in a testable artifact in software and hardware signals running in video controller 314. From this known signal injected from DRONE card 206, any error produced in video controller 314 can be debugged using system test software 316 in SUT's system memory 310. Similarly, hardware, such as I/O devices 318, coupled to Northbridge chipset 312 via an internal Southbridge chipset 320, may be stimulated (with a signal) to create a known condition that may cause an error, which can then be debugged using system test software 316.

A user interface 230 is able to communicate with DRONE card 206 via an Ethernet 226 and an Ethernet port 232, since system memory 218 includes an operating system 222 and a browser 224 that allows DRONE card to use IP addresses for communication. Alternatively, DRONE card 206 can communicate with user interface 230 via a serial line 228 and an RS232 port 234. That is, communication with DRONE card 206 can be accomplished via a web based or telnet session (using Ethernet port 232), or user interface 230 can function as a “dumb” terminal that communicates with DRONE card 206 via RS232 port 234.

Continuing now with a description of components depicted in FIG. 3, note that system memory 310 includes an operating system 322 and a browser 324, which permit SUT 302 to communicate with DRONE card 206 using the Internet Protocol (IP). Note also that a front-side bus 326 couples system memory 310 and Central Processing Unit (CPU) 328 to Northbridge chipset 312. Further notice is made of memory mapped registers 332 and DRONE software 334. Memory mapped registers 332 contain data having an address in system memory 310 that has been created out of a PCI area of system memory 310 for storing debug data 308. That is, data generated during debugging operations in SUT 302 is stored in system memory 310 (in an area dedicated to PCI bus communication) as well as in memory mapped registers 332 (which are mapped to the area in system memory 310 that is dedicated to PCI bus communication). Drone software 334, as described below, drives various I/O ports (212a-f in FIG. 2) to further stimulate the SUT 302 and trigger hardware events for hardware or software debugging.

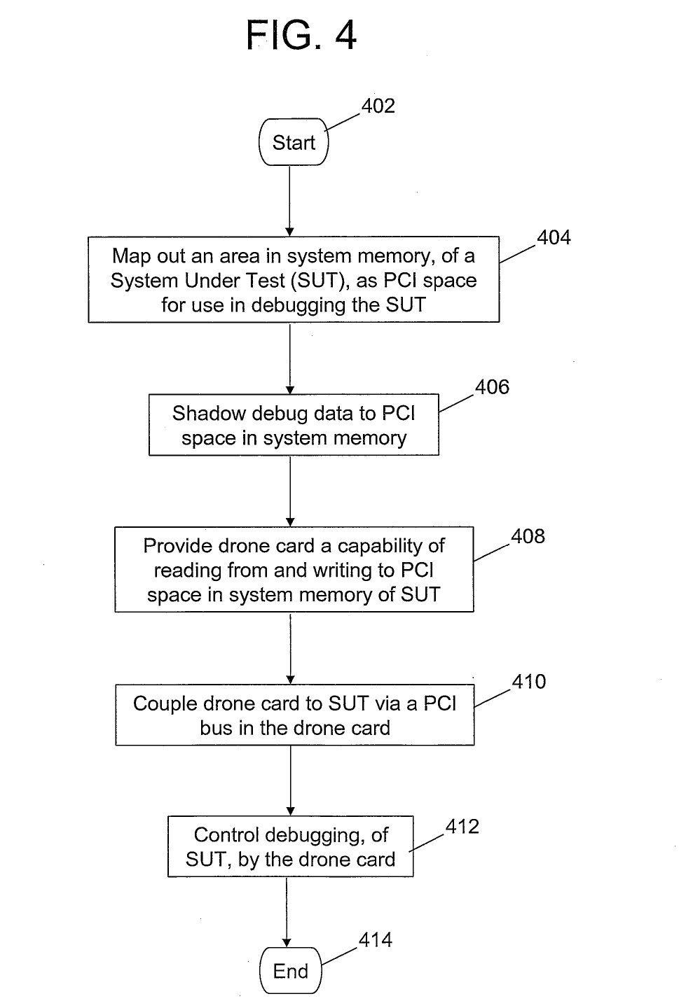

Referring now to FIG. 4, a flow-chart of exemplary steps taken by the present invention is presented. After initiator block 402, an area of system memory 310 is mapped to a PCI space for access by DRONE card 206 via PCI bus 204. As described at block 406, debug data from the System Under Test (SUT) is shadow-copied to the PCI space in system memory 310. By being located in this PCI space, the debug data can be placed directly on the PCI bus of the SUT, which can be used to transmit the debug data (in parallel mode) directly to the DRONE card 206 (as shown in FIG. 3 above). Thus, the DRONE card 206 has the capability of both directly reading debug data from the SUT's system memory, as well as directly writing data (e.g., triggering data) directly into the PCI space (block 408). Furthermore, since data on the PCI bus is controlled in part by the PCI space in the SUT's system memory, other trigger signals (including those for hardware components) can be placed directly onto the SUT's PCI bus, such that the DRONE card is able to manipulate the testing and debugging of both software and hardware in the SUT (block 410). The process, as described, thus ends at terminator block 412.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Note further that, as described above, instructions used in each embodiment of a computer-usable medium may be deployed from a service provider to a user. This deployment may be made in an “on-demand” basis as described herein.

The present invention thus presents a method, system, and computer-readable medium for debugging a System Under Test. The method may include the steps of: selecting a component of a System Under Test (SUT) for debugging; mapping out an area of system memory, in the SUT, as Peripheral Component Interface (PCI) space for storing debug data for the component that is selected for debugging; storing a copy of the debug data in the PCI space that has been mapped out in system memory in the SUT; and coupling a DRONE card to a PCI bus in the SUT, wherein the DRONE card reads debug data to and writes debug data from the PCI space that has been mapped out in system memory in the SUT. The method may further include the steps of coupling the SUT to the DRONE card via an Inter Integrated Circuit (I2C) bus; and configuring hardware in the SUT, via the I2C bus, under a control of the DRONE card. In another embodiment, the method includes the steps of coupling the SUT to the DRONE card via a General Purpose Input/Output (GPIO) port; and synchronizing, via the GPIO and under a control of the DRONE card, debug data that is stored to and read from the PCI space. Alternatively, the method may include the steps of coupling the SUT to the DRONE card via a General Purpose Input/Output (GPIO) port; and controlling, via the GPIO and under a control of the DRONE card, powering up and resets of the SUT. Static memory in the SUT may be emulated by providing shadow copies of debug data in dynamic memory that is located in the DRONE card. Furthermore, the method may include the steps of storing a copy of the debug data in memory mapped registers, located in the SUT, whose memory mapped addresses correspond with the PCI space that has been mapped out in system memory in the SUT; coupling the DRONE card to the memory mapped registers via the PCI bus in the SUT, wherein the DRONE card reads debug data to and writes debug data from the memory mapped registers in the SUT; and stimulating at least one Input/Output (I/O) port, in the SUT, by the DRONE card to trigger a hardware event for debugging operations in the SUT. The steps described herein may be used during debugging operations for hardware as well as software components of the SUT.

As thus described, the present invention provides a method and system for retrieving system status and debug information from an SUT with minimal disturbance to the normal software flow and hardware operation using a low-cost, highly configurable debug environment from a single piece of lab equipment (DRONE card).

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method of debugging a System Under Test (SUT), the method comprising:
selecting a component of a System Under Test (SUT) for debugging;
mapping out an area of system memory, in the SUT, as Peripheral Component Interface (PCI) space for storing debug data for the component that is selected for debugging;
storing a copy of the debug data in the PCI space that has been mapped out in system memory in the SUT; and
coupling a DRONE card to a PCI bus in the SUT, wherein the DRONE card reads debug data to and writes debug data from the PCI space that has been mapped out in system memory in the SUT.

2. The method of claim 1, further comprising:
coupling the SUT to the DRONE card via an Inter Integrated Circuit (I2C) bus; and
configuring hardware in the SUT, via the I2C bus, under a control of the DRONE card.

3. The method of claim 1, further comprising:
coupling the SUT to the DRONE card via a General Purpose Input/Output (GPIO) port; and
synchronizing, via the GPIO and under a control of the DRONE card, debug data that is stored to and read from the PCI space.

4. The method of claim 1, further comprising:
coupling the SUT to the DRONE card via a General Purpose Input/Output (GPIO) port; and
controlling, via the GPIO and under a control of the DRONE card, powering up and resets of the SUT.

5. The method of claim 1, further comprising:
emulating static memory in the SUT by providing shadow copies of debug data in dynamic memory that is located in the DRONE card.

6. The method of claim 1, further comprising:
storing a copy of the debug data in memory mapped registers, located in the SUT, whose memory mapped addresses correspond with the PCI space that has been mapped out in system memory in the SUT; and
coupling the DRONE card to the memory mapped registers via the PCI bus in the SUT, wherein the DRONE card reads debug data to and writes debug data from the memory mapped registers in the SUT.

7. The method of claim 1, further comprising:
stimulating at least one Input/Output (I/O) port, in the SUT, by the DRONE card to trigger a hardware event for debugging operations in the SUT.

8. The method of claim 1, further comprising:
debugging a hardware component of the SUT through a use of all operations described in claim 1.

9. The method of claim 1, further comprising:
debugging a software component of the SUT through a use of all operations described in claim 1.

9. A system for debugging a System Under Test (SUT), the system comprising:
a microprocessor to be debugged;
a Peripheral Component Interface (PCI) bus in an external Southbridge, wherein the PCI bus in the external Southbridge is coupled to a PCI bus in the SUT via a PCI-to-PCI bridge;
a DRONE card that is coupled to the SUT via the PCI bus in the external Southbridge; and
a system memory in the microprocessor to be debugged, wherein an area of the system memory is mapped out as Peripheral Component Interface (PCI) space for storing debug data for a component in the SUT that is selected for debugging, and wherein a copy of the debug data is stored in the PCI space that has been mapped out in system memory in the SUT, and wherein the DRONE card, during debugging operations in the SUT, reads debug data to and writes debug data from the PCI space that has been mapped out in system memory in the SUT.

10. The system of claim 9, further comprising:
an Inter Integrated Circuit (I2C) port on the DRONE card, wherein the DRONE card is coupled to the SUT via an I2C bus, and wherein the DRONE card configures hardware in the SUT via the I2C bus.

11. The system of claim 9, further comprising:
a General Purpose Input/Output (GPIO) port on the DRONE card, wherein the SUT is coupled to the DRONE card via the GPIO port, and wherein the DRONE card synchronizes a read operation and a write operation of debug data in the PCI space.

12. The system of claim 9, further comprising:
a General Purpose Input/Output (GPIO) port on the DRONE card, wherein the SUT is coupled to the DRONE card via the GPIO port, and wherein the DRONE card controls power-ups and resets of the SUT via the GPIO port.

13. The system of claim 9, further comprising:
memory mapped registers in the SUT, wherein the memory mapped registers store a copy of the debug data, and wherein the memory mapped registers have memory mapped addresses that correspond with the PCI space that has been mapped out in system memory in the SUT, and wherein the memory mapped registers are coupled to the DRONE card via the PCI bus in the SUT, such that the DRONE card reads debug data to and writes debug data from the memory mapped registers in the SUT.

14. A computer-usable medium embodying computer program code, the computer program code comprising computer executable instructions configured for:
selecting a component of a System Under Test (SUT) for debugging;
mapping out an area of system memory, in the SUT, as Peripheral Component Interface (PCI) space for storing debug data for the component that is selected for debugging;
storing a copy of the debug data in the PCI space that has been mapped out in system memory in the SUT; and
coupling a DRONE card to a PCI bus in the SUT, wherein the DRONE card reads debug data to and writes debug data from the PCI space that has been mapped out in system memory in the SUT.

15. The computer-usable medium of claim 14, wherein the computer executable instructions are further configured for:
in response to a coupling of the SUT to the DRONE card via an Inter Integrated Circuit (I2C) bus, configuring hardware in the SUT, via the I2C bus, under a control of the DRONE card.

16. The computer-usable medium of claim 14, wherein the computer executable instructions are further configured for:
in response to a coupling of the SUT to the DRONE card via a General Purpose Input/Output (GPIO) port, synchronizing, via the GPIO and under a control of the DRONE card, debug data that is stored to and read from the PCI space.

17. The computer-usable medium of claim 14, wherein the computer executable instructions are further configured for:
in response to a coupling of the SUT to the DRONE card via a General Purpose Input/Output (GPIO) port, controlling, via the GPIO and under a control of the DRONE card, powering up and resets of the SUT.

18. The computer-usable medium of claim 14, wherein the computer executable instructions are further configured for:
storing a copy of the debug data in memory mapped registers, located in the SUT, whose memory mapped addresses correspond with the PCI space that has been mapped out in system memory in the SUT; and
in response to a coupling of the DRONE card to the memory mapped registers via the PCI bus in the SUT, utilizing the DRONE card to read debug data to and to write debug data from the memory mapped registers in the SUT.

19. The computer-usable medium of claim 14, wherein the computer executable instructions are further configured for:
stimulating at least one Input/Output (I/O) port, in the SUT, by the DRONE card to trigger a hardware event for debugging operations in the SUT.

20. The computer-usable medium of claim 14, wherein a hardware component of the SUT is performed through a use of all operations described in claim 14.
